(19) United States
(12) Patent Application Publication
(10) Pub. No.: US 2015/0208841 A1
(43) Pub. Date: Jul. 30, 2015

(54) MULTI-PURPOSE UTENSIL MAT

(71) Applicants: Edmund Damont Hardimon, Marietta, GA (US); Cassandra Ann Hardimon, Marietta, GA (US)

(72) Inventors: Edmund Damont Hardimon, Marietta, GA (US); Cassandra Ann Hardimon, Marietta, GA (US)

(21) Appl. No.: 14/610,166

(22) Filed: Jan. 30, 2015

Related U.S. Application Data
(60) Provisional application No. 61/933,570, filed on Jan. 30, 2014.

(51) Int. Cl. A47G 23/03; G06F 17/30

(52) U.S. Cl. CPC A47G 23/0306; G06F 17/30

(57) ABSTRACT

Implementations of a multi-purpose utensil mat are provided. In some implementations the utensil mat may be flat, rectangular material. In some implementations, the utensil mat, unlike placemats, does not occupy a relatively large area of the table. In some implementations, the utensil mat is configured such that no more than three eating utensils can be placed completely on the mat. In some implementations, the utensil mat comprises an antibacterial or antimicrobial coating on its surface. In some implementations, the utensil mat may include perforations to detach a portion of the utensil mat. In some implementations, the utensil mat includes a matrix barcode that can be used with a smartphone to retrieve information, games, videos, music, or other content. In some implementations, the utensil mat may include a menu on the front or back of the mat.

### CROSS REFERENCE TO RELATED APPLICATION

This application claims the benefit of U.S. Patent Application Ser. No. 61/933,570, which was filed on Jan. 30, 2014, and is incorporated herein by reference in its entirety.

### TECHNICAL FIELD

This disclosure relates to implementations of a multi-purpose utensil mat.

### BACKGROUND

Place mats are primarily used to protect an underlying table. Place mats also are used for decoration. In restaurants, for example, placemats can be used for entertainment (e.g., the placemat may have games printed thereon for kids) or advertisement. Still further, place mats may be used to catch spills and food for easy clean-up after eating.

However, place mats are relatively large. The typical place mat is rectangular and designed to accommodate plates, glasses, silverware, and other dining equipment. Typical sizes of place mats are 12 inches wide by 18 inches long or 14 inches wide by 20 inches long. Such large place mats can be unsightly and some restaurants, for example, do not use place mats for various reasons.

With the lack of place mats on tables, diners have fewer options for placing their utensils while eating. A diner can place their utensils on a plate or directly on the table or tablecloth. However, placing utensils on a plate can be cumbersome. Furthermore, placing utensils on a table or tablecloth can be unsanitary or messy.

U.S. Patent Appl. Pub. No.2013/0216755 attempts to address the above concerns. U.S. Patent Appl. Pub. No.2013/0216755 discloses a utensil mat attached to or laid upon a table for the protection of eating utensils. However, the utensil mat disclosed in U.S. Patent Appl. Pub. No.2013/0216755 is very limited.

### BRIEF DESCRIPTION OF THE DRAWINGS

FIG. 1 illustrates an example implementation of a multi-purpose utensil mat according to the present disclosure.

### DETAILED DESCRIPTION

Implementations of a multi-purpose utensil mat are provided. In some implementations, the utensil mat may be a flat, rectangular material. In some implementations, the utensil mat, unlike placemats, does not occupy a relatively large area of the table. In some implementations, the utensil mat is configured such that no more than three eating utensils can be placed completely on the mat. In some implementations, the utensil mat comprises an antibacterial or antimicrobial coating on its surface. In some implementations, the utensil mat may include perforations to detach a portion of the utensil mat. In some implementations, the utensil mat includes a matrix barcode that can be used with a smartphone to retrieve information, games, videos, music, or other content. In some implementations, the utensil mat may include a menu on the front or back of the mat.

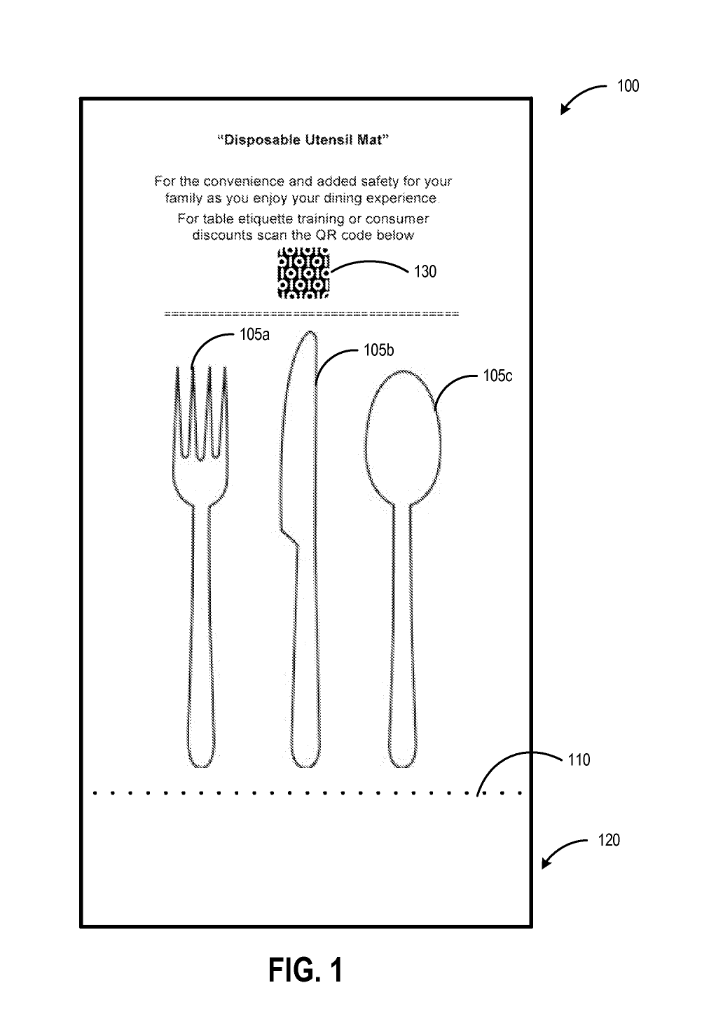

FIG. 1 illustrates an example implementation of a multi-purpose utensil mat 100 according to the present disclosure. In some implementations, the utensil mat 100 may be a flat, rectangular material. In some implementations, the length to width ratio of the utensil mat 100 is at least 2. In some implementations, the length to width ratio is less than 2.

In some implementations, the width of utensil mat 100 is no more than 5 inches. In some implementations, the width of utensil mat 100 is greater than 5 inches. In this way, the utensil mat 100, unlike placemats, does not occupy a relatively large area of the table.

In some implementations, the utensil mat 100 is configured such that at least three eating utensil (e.g., one fork 105a, one knife 105b, and one spoon 105c) may be placed completely on the mat 100. In some implementations, the utensil mat 100 is configured such that no more than three eating utensils can be placed completely on the mat. In some implementations, the utensil mat 100 is configured such that no more than four eating utensils can be placed completely on the mat.

Unlike a place mat, the utensil mat 100 is space efficient, may not compete with the decor of the table, and may be placed in a variety of positions on the table.

In some implementations, the utensil mat 100 is disposable. In some implementations, the utensil mat 100 comprises biodegradable matter. In some implementations, the utensil mat 100 is manufactured from paper. In some implementations, the utensil mat 100 is manufactured from a nonwoven fabric. In some implementations, the utensil mat 100 is manufactured from any suitable material.

In some implementations, the utensil mat 100 comprises an antibacterial or antimicrobial coating on its surface. In some implementations, the utensil mat 100 is manufactured from an antimicrobial material. In some implementations, the utensil mat 100 comprises an antimicrobial surface. In this way, the ability for microorganisms to grow on or near the utensil mat 100 may be reduced.

In some implementations, the utensil mat 100 may be skid or slide resistant.

In some implementations, the utensil mat 100 may include perforations 110 to detach a portion 120 of the utensil mat 100. The detachable portion 120 may include information, advertising, games, or coupons, any other content, or no content (e.g., a note taking area). In some implementations, the perforations 110 extend width-wise along a bottom portion of the utensil mat 100. In some implementations, the perforations extend width-wise along a top portion of the utensil mat 100. In some implementations, the perforations extend length-wise along a side portion of the utensil mat 110.

In some implementations, the utensil mat 100 includes a matrix barcode such as QR (Quick Response) code 130 that can be used with a smartphone to retrieve information, games, videos, music, or other content. For example, the matrix barcode can be used to retrieve a wide variety of information such as table etiquette, menus, advertisements including advertisements of third parties, discounts, coupons, dinner conversations questions, or any other information.

In some implementations, the utensil mat 100 may include a menu on the front or back of the mat.

To use the utensil mat 100, the mat 100 may be placed on a table or other surface. Then, one or more eating utensils are placed on top of the mat 100.

In some implementation, for example, at a restaurant, a customer may use a smart phone to capture the matrix barcode printed on the mat 100 to retrieve information, games, videos, music, or any other content.

In some implementations, a customer may detach a portion of the utensil mat 100 along the perforations to, for example, play a game printed on the detachable portion, or carry away information printed on the detachable portion.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A utensil mat article comprising:
a flat, rectangular material having a length to width ratio of at least 2 and configured such that no more than four eating utensils can be placed completely on the material; wherein at least a portion of the material includes an antimicrobial coating.

2. The utensil mat of claim 1 further comprising perforations to detach a portion of the utensil mat.

3. The utensil mat of claim 2 wherein the detachable portion includes a game.

4. The utensil mat of claim 1 wherein the material includes a matrix barcode imprinted thereon.

5. The utensil mat of claim 4 wherein the matrix barcode is configured to be used with a smartphone to link to games.

6. The utensil mat of claim 4 wherein the matrix barcode is configured to be used with a smartphone to provide information.

7. The utensil mat of claim 6 wherein the information includes advertisements of third parties.

8. The utensil mat of claim 6 wherein the information includes discounts or coupons.

9. The utensil mat of claim 4 wherein the matrix barcode is configured to be used with a smartphone to link to videos.

10. The utensil mat of claim 4 wherein the matrix barcode is configured to be used with a smartphone to link to music.

11. The utensil mat of claim 1 wherein the material is a nonwoven fabric.

12. The utensil mat of claim 1 wherein no more than three eating utensils can be placed completely on the mat.

13. The utensil mat of claim 1 wherein the material includes a menu imprinted thereon.

14. A utensil mat article comprising:
a flat, rectangular material having a length to width ratio of at least 2 and configured such that no more than four eating utensils can be placed completely on the mat; wherein the material includes a matrix barcode imprinted thereon.

15. A method of using a utensil mat wherein the utensil mat comprises a flat, rectangular material having a length to width ratio of at least 2 and configured such that no more than four eating utensils can be placed completely on the mat, the method comprising:
placing the utensil mat on a surface; and
placing one or more utensils on top of the mat.

16. The method of claim 15 wherein the material includes a matrix barcode imprinted thereon, the method further comprising using a smart phone to capture the matrix barcode printed thereon to retrieve content.

17. The method of claim 15 wherein the content comprises games.

18. The method of claim 15 wherein the content comprises advertisements.

19. The method of claim 15 wherein the material includes perforations to detach a portion of the utensil mat, the method further comprising detaching a portion of the utensil mat along the perforations.

20. The method of claim 15 wherein at least a portion of the material includes an antimicrobial coating.
